(19) United States
(12) Patent Application Publication
(10) Pub. No.: US 2022/0164968 A1
(43) Pub. Date: May 26, 2022

(54) AUTOMATED CORE SCAN ALIGNMENT

(71) Applicant: Halliburton Energy Services, Inc., Houston, TX (US)

(72) Inventors: Yangqiu Hu, San Antonio, TX (US); Naum Moiseyevich Derzhi, Houston, TX (US); Jonas Toelke, Houston, TX (US)

(21) Appl. No.: 17/593,947

(22) PCT Filed: Apr. 29, 2019
(86) PCT No.: PCT/US2019/029693

§ 371 Date: Sep. 28, 2021

(51) Int. Cl. G06T 7/33; G06T 7/60; G06T 3/60; G06V 10/74; G06V 10/75; G06T 7/136; G06T 7/13; G06T 7/155; G06T 17/00

(52) U.S. Cl. CPC G06T 7/33; G06T 7/60; G06T 3/60; G06V 10/761; G06T 2207/20036; G06T 7/136; G06T 7/13; G06T 7/155; G06T 17/00; G06V 10/7515

(57) ABSTRACT

A core scan alignment service processes core scans to automatically perform, longitudinal and rotational alignment of core sample images. The alignment service fits ellipses to a core sample represented in an image and fits a line through the center of the ellipses to determine a center axis of the image. The alignment service aligns the determined center axis of the image with center axes of other processed images. The alignment service also rotates the image around the central axis while comparing sub-volumes or portions of the image with an adjacent previously aligned image. The alignment service determines a similarity metric between the neighboring images at several rotational positions. The alignment service then rotates the image to a degree of rotation which yielded the highest similarity metric value. The alignment service can output a three-dimensional model or image of an aligned set of core sample images.

### TECHNICAL FIELD

The disclosure generally relates to the field of subsurface characterization and more particularly to formation core analysis.

### BACKGROUND

Core analysis of a core sample from a borehole in a formation provides a means of measuring downhole conditions to determine formation properties such as permeability, porosity, and other characteristics of the formation/borehole. In addition, a core analysis is useful for well log calibration and providing direct evidence of the presence, distribution, and deliverability of hydrocarbon. Core analysis provides important information useful to determine the optimal values for various parameters during formation drilling and hydrocarbon production such as when to drill, what a target depth for fracturing should be, which wells to inject with fluids, etc. During conventional coring operations, the operator first drills the well down to a zone of interest using a drill bit and drill string and extracts one or more core samples. The core samples can be further analyzed by imaging the core samples using scanners or techniques for computed X-Ray tomography (CT) scans, magnetic resonance imaging (MRI) scans, etc.

### BRIEF DESCRIPTION OF THE DRAWINGS

Aspects of the disclosure may be better understood by referencing the accompanying drawings.

FIG. 1 depicts example operations of a core scan alignment service.

FIG. 2 depicts a flowchart with example operations for aligning core sample images.

FIG. 3 depicts a flowchart with example operations for performing longitudinal alignment of two core sample images.

FIG. 4 depicts a flowchart with example operations for performing rotational alignment of two core sample images.

FIG. 5 depicts an example core sample image with fitted ellipses and a fitted cylindrical shell.

FIG. 6 illustrates the process of aligning a core sample image with a previously aligned core sample image.

FIG. 7 depicts two sets of core sample images before and after alignment.

FIG. 8 illustrates an example system for collecting core samples.

FIG. 9 depicts an example computer system with a core scan alignment service.

### DESCRIPTION OF EMBODIMENTS

The description that follows includes example systems, methods, techniques, and program flows that embody aspects of the disclosure. However, it is understood that this disclosure may be practiced without these specific details. For instance, this disclosure refers to aligning scans or images of core samples in illustrative examples. Aspects of this disclosure can be also applied to aligning scans or images of other objects. In other instances, well-known instruction instances, protocols, structures and techniques have not been shown in detail in order not to obfuscate the description.

### Overview

Extracted core samples can vary in size and length and may break during the coring process. Additionally, the alignment of core samples during the scanning process is unlikely be uniform from scan to scan. As a result, core sample images in the core scans are not easily aligned when attempting to compile or reconstruct the core scans into a representation or model of a downhole formation. Manual alignment of the core sample images can be time consuming and may be impossible using the human eye alone. To solve these problems, a core scan alignment service is proposed which automatically processes core scans to perform longitudinal and rotational alignment of core sample images in the scans. To align a core sample image, the alignment service fits ellipses to border pixels of a core sample represented in the image and fits a line through the center of the ellipses to determine a center axis of the core sample image. The alignment service aligns the determined center axis of the core sample image with center axes of other processed core sample images. The alignment service then rotates the core sample image around the central axis while comparing sub-volumes or portions of the core sample image with a neighboring previously aligned core sample image. The alignment service determines a similarity metric between the core sample image and the neighboring core sample image at a number of rotational positions. The alignment service then rotates the core sample image to a degree of rotation which yielded the highest similarity metric value. After processing a set of core sample images, the alignment service can output a three-dimensional model or image of the aligned core sample images depicting a formation from which the scanned core samples were extracted.

### Terminology

The description below uses the term “core sample image” to refer to a digital representation of a core sample. After extraction from a formation, a core sample is scanned to generate a core scan. A core scan can comprise multiple files with image data and metadata information indicating properties such as a scanning protocol. A core sample image can be extracted from the core scan files for alignment with other core sample images. Alignment operations as described herein, such as rotations and translations, are understood to refer to digitally manipulating the core sample image and not to physical manipulations of a core sample.

### Example Illustrations

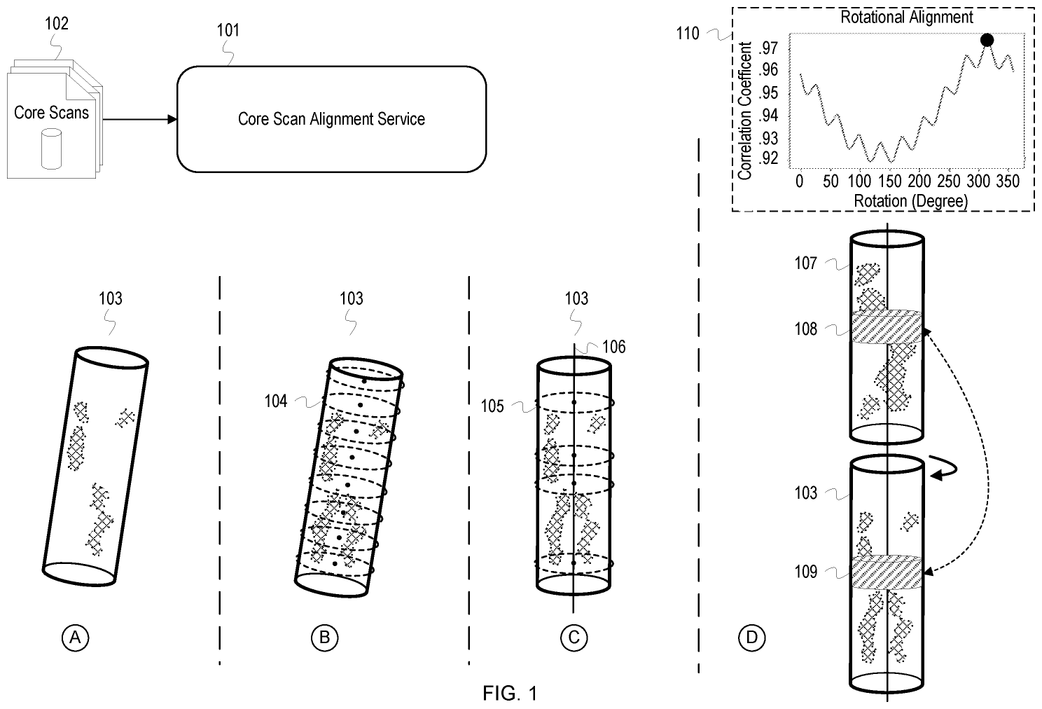

FIG. 1 depicts example operations of a core scan alignment service. FIG. 1 depicts a core scan alignment service 101 (“alignment service 101”) that processes core scans 102 which are input into the alignment service 101. The alignment service 101 can be software executing on a server or computer or can be a combination of hardware and software components. For example, the alignment service 101 may utilize hardware to perform image processing operations on core sample images the core scans 102.

At stage A, the alignment service 101 begins processing of a core sample image 103 from the core scans 102. The core scans 102 each comprise three-dimensional image data for a core sample extracted from a borehole. The core scans 102 may have been generated by a CT scan or MRI and may be stored in a three-dimensional image file, such as a Digital Imaging and Communications in Medicine (DICOM) file. Each of the core scans 102 can be associated with attributes such as an origin of the core sample, diameter of the core sample, length of the core sample, etc. The origin of a core sample may be from which borehole a core sample was retrieved or the depth at which the sample was taken. The associated diameter and length of the core sample may be determined from the CT scan data or may be determined based on an apparatus, e.g. an aluminum core sample tube, utilized during retrieval of the sample. The alignment service 101 selects the core sample image 103 from the core scans 102 for processing.

At stage B, the alignment service 101 fits ellipses 104 to border pixels of the core sample image 103 to determine a center and radius at multiple points along the core sample image 103. The alignment service 101 applies binary thresholding and morphological operations to each axial image of the core sample image 103 to identify border pixels, i.e., pixels which lie on an outer boundary of the core sample in the core sample image 103. The alignment service 101 fits the ellipses 104, which may be circles in some implementations, to the identified border pixels. For each of the fitted ellipses 104, the alignment service 101 compares a center or radius of the fitted ellipse to a known center or radius of the core sample to determine a goodness of fit or accuracy of the ellipse. The goodness of fit can be determined, for example, by using the following mean squared difference (MSD) formula to determine residual error between the center of the fitted ellipse and the known center:

$$MSD ( X , Y ) = \frac{1}{N} {\sum }_{i}^{N} {( {x}_{i} - {y}_{i} )}^{2} \qquad ( 1 )$$

where N is equal to the number of ellipses, X includes the centers or radii of each of the fitted ellipses 104, and Y includes the known centers or radii for the core sample image 103.

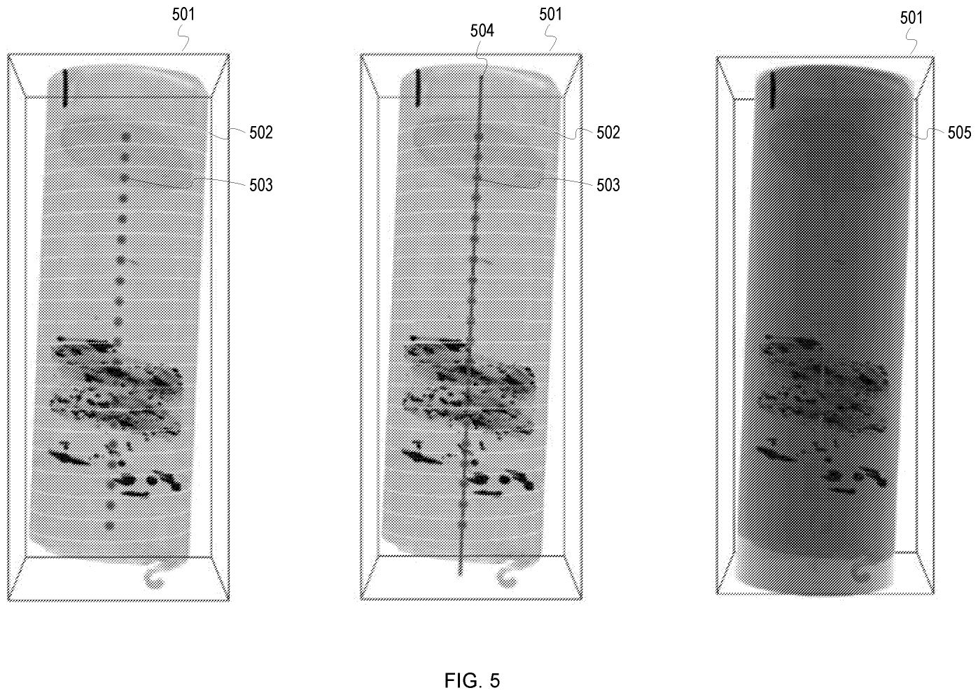

At stage C, the alignment service 101 utilizes the fitted ellipses 105 selected from the fitted ellipses 104 and determines a center axis 106 for the core sample image 103. After calculating the residual error for the fitted ellipses 104, the alignment service 101 selects a top fraction of ellipses which are determined to have a best fit, i.e., the least residual error. For example, the alignment service 101 may select the top 60% of the fitted ellipses 104. The alignment service 101 then determines the center point of each of the selected fitted ellipses 105 and fits a line to the center points to be the center axis 106 of the core sample image 103. The core sample image 103 is then rotated or tilted to longitudinally align the center axis 106 with a z-axis. In some implementations, the alignment service 101 also fits a cylindrical shell to the core sample image 103 using the radii of the fitted ellipses 104 as described in more detail in FIG. 5. In addition to orienting the core sample image 103 to be parallel with a z-axis, the alignment service 101 also positions the core sample image 103 within an xy coordinate plane so that the axis 106 is aligned with a previously processed core sample image, such as the core sample image 107 depicted at stage D.

At stage D, the alignment service 101 determines a rotational alignment between the core sample image 103 and the core sample image 107. While rotational alignment may be considered optional in some implementations, rotational alignment improves the visualization of geologic features that exhibit continuity across multiple sample images, such as beddings and vertical fractures. The core sample image 107 is a core sample image from the core scans 102 which was previously aligned by the alignment service 101. The alignment service 101 selects a sub-volume 108 from the core sample image 107 and a sub-volume 109 from the core sample image 103 for comparison in determining the correct rotational alignment of the core sample images. The size, e.g., a depth of 1 foot, 2 feet, 30 centimeters, 1 meter, etc., and location of the selected sub-volumes can vary; however, selecting the sub-volumes from the center of core sample images can be beneficial since the end portions of the core samples are often damaged or modified during the core sample process. A larger sub-volume generally leads to a more accurate rotational alignment since more information is compared but is more computationally intensive. To compare the sub-volumes, the alignment service 101 iteratively rotates the sub-volume 109 from 0-360 degrees about the z-axis while the sub-volume 108 remains stationary. The alignment service 101 determines a similarity metric between the sub-volumes at each specified degree of rotation. The alignment service 101 can determine a similarity metric for each whole degree, every tenth of a degree, or may utilize a coarse scale such as every fifth degree, i.e., 0, 5, 10, etc. The rotation causes different voxels to be compared between the sub-volume 108 and the sub-volume 109 at each unique position in the rotation. The rotation of the sub-volume 109 may be done logically, i.e., the sub-volume 109 is not actually or digitally rotated but, rather, the corresponding voxels are selected for comparison at each rotational position as if the sub-volume 109 had been rotated.

As shown in the rotational alignment graph 110 in FIG. 1, the alignment service 101 determines a similarity metric between the sub-volumes based on a correlation coefficient. Correlation coefficient can be expressed using the following formula:

$$ρ ( X , Y ) = \frac{cov ( X , Y )}{{σ}_{X} {σ}_{Y}} \qquad ( 2 )$$

where cov( ) is the covariance, σₓ is the standard deviation of X, and σ_{y} is the standard deviation of Y. The variables X and Y comprise values or attributes of the sub-volume 108 and the sub-volume 109 which are being compared. For example, X and Y can comprise intensity values for each voxel in the sub-volumes, where intensity is the presence of a color such as gray. In other implementations, the similarity metric can be determined using a mean squared difference formula such as formula (1) above where N is the number of voxels or using a mutual information formula. Mutual information or a measure of the mutual dependence between two variables can be expressed as follows:

$$I ( X , Y ) = {\sum }_{y ∈ Y} {\sum }_{x ∈ X} p ( x , y ) log ( \frac{p ( x , y )}{p ( x ) p ( y )} ) \qquad ( 3 )$$

where p(x, y) is the joint probability function of X and Y, and p(x) and p(y) are the marginal probability distribution functions of X and Y, respectively. The variables X and Y again comprise values or attributes of the sub-volume 108 and the sub-volume 109 which are being compared. Generally, when using correlation coefficient and MSD functions, the core sample images being compared should be of the same modality, both CT scans. Mutual information, however, may be used when two core sample images are of different modalities, e.g., one a CT scan and one an MRI. If the alignment service 101 detects that two sample images being compared are of different modalities, the alignment service 101 can utilize the mutual information formula to calculate similarity metrics for the core sample images.

After determining a similarity metric for each degree of rotation, the alignment service 101 identifies a degree with the highest similarity metric. As shown in the rotational alignment graph 110, the degree of rotation which resulted in the highest similarity metric value based on the correlation coefficient lies in the range between 300-350 degrees. The alignment service 101 rotates the core sample image 103 to the identified degree and aligns the core sample image 103 and the core sample image 107. In some implementations, the alignment service 101 may perform multiple passes of rotational alignment by identifying ranges of degrees which exhibited the highest similarity metric values and refining the rotation to a finer degree. For example, the alignment service 101 can identify from the rotational alignment graph 110 that the range from 310 to 330 degrees exhibits high similarity metric values. The alignment service 101 then calculates similarity metrics in this range at degrees to the tenth decimal place: 310.1, 310.2, . . . 329.9, 330.0. The alignment service 101 can repeat this process to continue refining the rotational alignment to a specified decimal place, such as hundredths or thousandths.

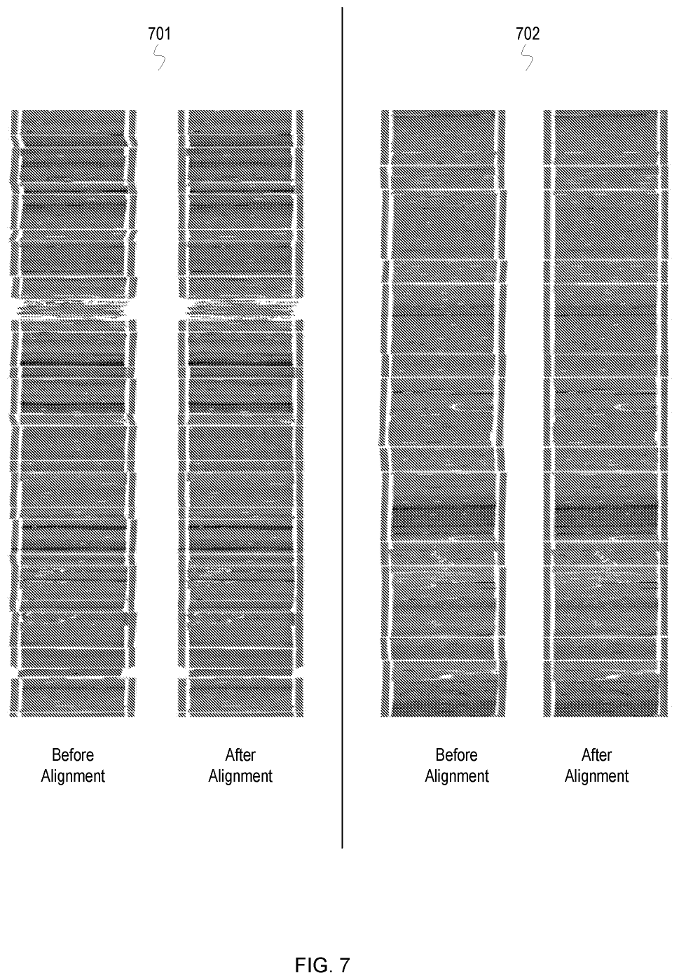

The alignment service 101 repeats stages A-D for each of the core scans 102. Once each of the core scans 102 has been longitudinally and rotationally aligned, the alignment service 101 may output a final image or model containing the aligned core sample images. The alignment service 101 may also perform additional processing on the image such as removing an aluminum tube (like the tube depicted in FIG. 7) from the core sample images.

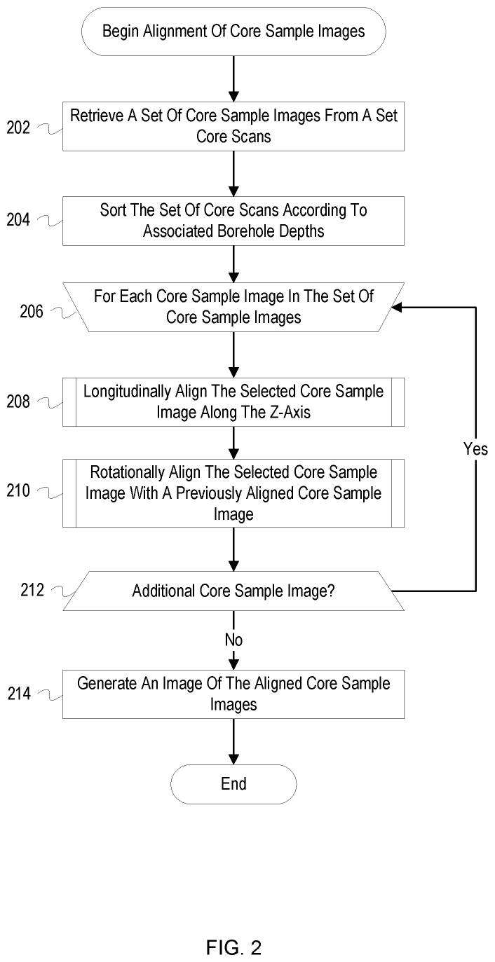

FIG. 2 depicts a flowchart with example operations for aligning core sample images. FIG. 2 refers to an alignment service as performing the operations for naming consistency with FIG. 1, although the naming of program code can vary among implementations.

An alignment service retrieves a set of core sample images from a set of core scans (202). The core scans may be generated using CT scans, MRIs, or other three-dimensional modeling technique for core samples. The service may open each file of the set of core scans to extract the set of core sample images. For example, the images may be copied from each of the core scan tiles and pasted into a same document used as a workspace for aligning the set of core sample images. The set of core sample images to be aligned represent a contiguous set of core samples extracted from a borehole or subterranean formation. Generally, a set of core samples are extracted from a continuous depth range such as 100-150 feet or 30-45 meters below a surface, and multiple sets of core samples can be extracted at various depth ranges. However, sample images of core samples collected from non-continuous depth ranges can be similarly aligned using the operations described herein. The core samples, and consequently the core sample images, may vary in size and length. For example, a first core sample may be 3 feet long (91.44 centimeters) and 4 inches (10.16 centimeters) in diameter, and a second core sample may be 2 feet long (60,96 centimeters) and 3 inches (22.86 centimeters) in diameter. The core samples are typically cylindrical in shape although other shapes, such as cubes or spheres, are possible. Moreover, core samples may break during extraction or transport. The broken pieces of core samples may be scanned separately and similarly aligned using the operations described herein.

The alignment service sorts the set of core sample images according to associated borehole depths (204). Each of the set of core sample images is tagged with a depth from which the corresponding core sample was extracted. Alternatively, the core sample images may be assigned numbers representing the ordering with which the core samples were extracted and should be reconstructed. The alignment service sorts the core sample images to be in a correct order for alignment. For example, a core sample image representing a depth of 100-105 feet or 30-32 meters may be aligned first followed by a core sample image representing a depth of 106-110 feet or 33-35 meters.

The alignment service begins alignment operations for the set of core sample images (206). The alignment service iterates through the set of core sample images according to the depth ordering determined at block 204. The alignment service may begin at the lowest depth or highest depth. The core sample image currently being aligned is hereinafter referred to as “the selected core sample image.”

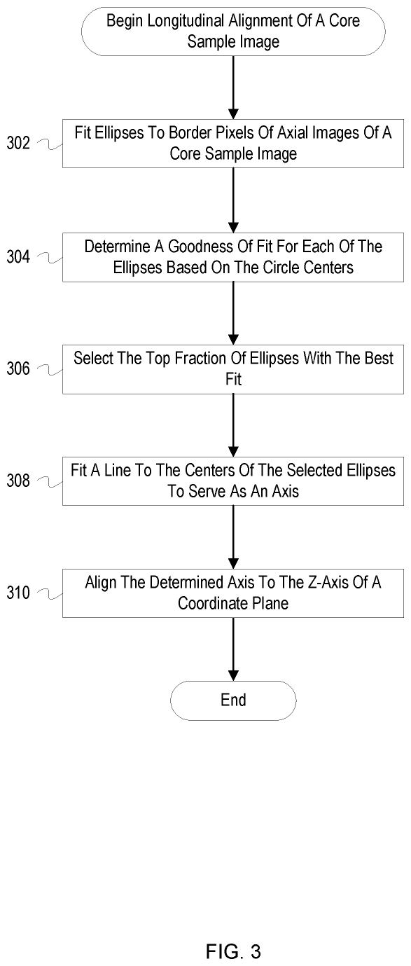

The alignment service longitudinally aligns the selected core sample image along the z-axis (208). The alignment service determines a center axis for a core sample represented in the selected core sample image and aligns the center axis to a z-axis of a coordinate plane used for aligning core sample images. The alignment service determines the center axis by fitting a plurality of ellipses along the length of a core sample represented in the selected core sample image and fitting a line through the centers of the ellipses. The longitudinal alignment process is described in more detail in FIG. 3.

The alignment service rotationally aligns the selected core sample image with a previously aligned core sample image (210). The alignment service compares the selected core sample image to a previously aligned core sample image at a number of rotational positions and determines a similarity of the core sample images at each position. Ultimately, the alignment service identities a degree of rotation of the selected core sample image relative to the previously aligned core sample image which causes the core samples represented in the core sample images to be roughly aligned as originally positioned in a formation. The previously aligned core sample image used for comparison during rotational alignment should be a core sample image adjacent to or neighboring the selected core sample image. If the selected core sample image is the first core sample image to be aligned in the set of core sample images, rotational alignment may not be necessary as there is not a previously aligned core sample image with which to compare and align. The rotational alignment process is described in more detail in FIG. 3.

The alignment service determines whether there is an additional core sample image (212). If there is an additional core sample image in the set of core sample images to be aligned, the alignment service selects the next core sample image for alignment (206).

If the set of core sample images has been aligned, the alignment service generates an image of the aligned core sample images (214). The alignment service may output a file containing a three-dimensional model of the aligned core sample images, output two-dimensional images of the aligned core sample images, etc. In some implementations, the alignment service or another software service can further process the aligned core sample image to identify regions of interest and crop out extraneous artifacts (such as tubing surrounding the core samples). After outputting the aligned core sample images, the process ends.

FIG. 3 depicts a flowchart with example operations for performing longitudinal alignment of two core sample images. FIG. 3 refers to an alignment service as performing the operations for naming consistency with FIG. 1, although the naming of program code can vary among implementations.

An alignment service fits ellipses to border pixels of axial images of a core sample image (302). The alignment service applies binary thresholding and morphological operations to each axial image in the core sample image to identify border pixels. Axial images are transverse images which depict “slices” of the core sample perpendicular to a longitudinal axis of the core sample. The number of axial images in a core sample image can vary depending on the size of the core sample and a CT scanning technique utilized. In general, binary thresholding replaces each pixel in an image with a black pixel if the image intensity is less than a specified value (typically between 0-255) or a white pixel if the image intensity is greater than the value. Applying binary thresholding transforms an axial image into a binary image on which morphological imaging processing operations can be applied to identify the borders of a core sample. A morphological operation on a binary image creates a new binary image in which the pixel has a non-zero value only if condition is met at that location (e.g., pixel or voxel) in the input image. A condition such as whether the pixel/voxel is black or white or is adjacent to a black or white pixel/voxel can be used to identify the edges of a core sample during an applied morphological operation. An ellipse is fitted to the identified border pixels in each axial image. The ellipse can be fitted to the border pixels using a least squares fitting algorithm.

The alignment service determines a goodness of fit for each of the ellipses based on the ellipse centers (304). The alignment service calculates a residual error for each of the ellipses based on a mean squared difference between the center of the fitted ellipse and a known center of the core sample determined from the core sample image. In some implementations, the alignment service determines an average center position of the fitted ellipses and then uses the average position as the known center of the core sample. The alignment service can also determine goodness of fit for each ellipse by calculating a difference in distance from the known or averaged ellipse center, the ellipses with the lowest distance having the better goodness of fit.

The alignment service selects the top fraction of ellipses with the best fit (306). In other words, the alignment service selects the ellipses with centers that have the least residual error. For example, the alignment service may select the top 60% of ellipses. In some implementations, the alignment service selects only ellipses whose residual error satisfies a threshold.

The alignment service fits a line to the centers of the selected ellipses to serve as an axis for the core sample image (308). The alignment service can fit a line to the ellipse centers using various techniques, such as the least square method or linear regression. The fitted line serves as a center axis of the core sample represented in the core sample image.

The alignment service aligns the determined axis to the z-axis of a coordinate plane (310). The alignment service uses a three-dimensional coordinate plane for aligning core sample images. The alignment service can use any of the axes for alignment so long as a common axis is used consistently among sample images. In this instance, the alignment service aligns the line fitted to the center of the core sample with the z-axis. The core sample image may include a marking or other indication of a top and bottom of the core sample represented in the core sample image, the top corresponding to a higher depth and the bottom corresponding to a lower depth of the core sample. The alignment service orients the core sample image in accordance with the top and/or bottom indications. Additionally, as part of longitudinally aligning the core scan, the alignment service positions or translates the core sample image to a location within an xy coordinate plane so that the determined axis for the core scan is at a same coordinate as a determined axis of the previously aligned core scan. Overall, the longitudinal alignment process involves performing rigid-body transformation (i.e., rotations and translations) on the regular grids of voxels of the core sample image to align the core sample image with other core sample images within a three-dimensional plane. After longitudinally aligning the core scan, the process ends.

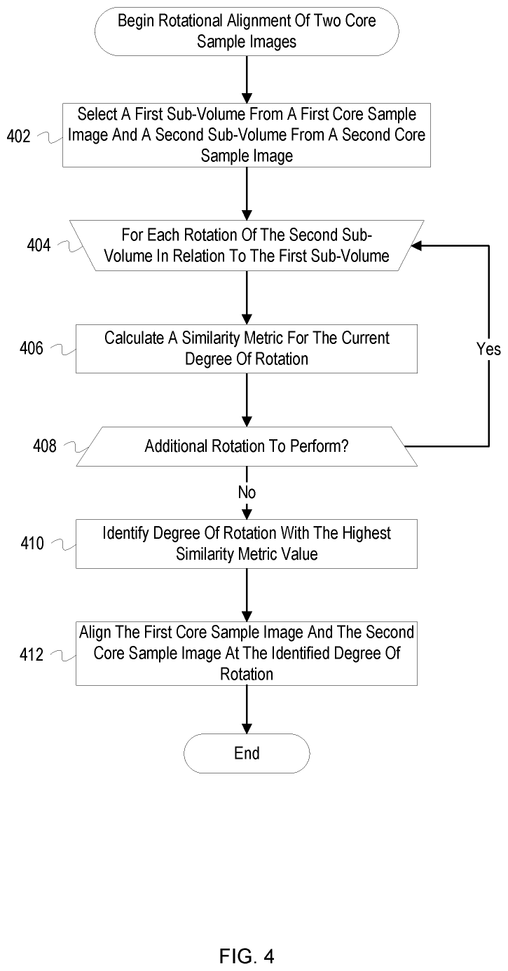

FIG. 4 depicts a flowchart with example operations for performing rotational alignment of two core sample images. FIG. 4 refers to an alignment service as performing the operations for naming consistency with FIG. 1, although the naming of program code can vary among implementations.

An alignment service selects a first sub-volume from a first core sample image and a second sub-volume from a second core sample image (402). The first core sample image is a previously aligned core sample image with which the second core sample image is being rotationally aligned. Selecting sub-volumes for comparison as opposed to entire core sample images reduces the computational burden. Additionally, sub-volumes can be strategically selected so as to avoid broken portions of a core sample or artifacts in a core sample image leading to better results during the alignment process. The size and shape of sub-volumes can vary depending upon the computing resources available and the size and shapes of the core samples represented in a core sample image. For example, the alignment service may select cylindrically shaped sub-volumes which are 3 feet or 1 meter in depth if the size of the core sample permits and may select spherically shaped sub-volumes 1 foot or 30 centimeters in diameter for smaller core samples or broken core pieces. In instances where limited computing resources are available, the alignment service may decrease the size of the sub-volumes or decrease a resolution of the core sample images/sub-volumes. For example, if the core sample image has a resolution of 300 voxels per cubic inch or 100 voxels per cubic centimeter, the alignment service can reduce the resolution of the core sample image or sub-volume using an algorithm for reducing image resolution such as the nearest neighbor down-sampling algorithm.

The alignment service begins determining an optimal rotational alignment for the second core sample image in relation to the first core sample image (404). The alignment service incrementally rotates the second sub-volume in relation to the first sub-volume. The alignment service determines a start position for the sub-volumes which is considered to have 0 degrees of rotation. For each iteration, the alignment service rotates the second sub-volume about the z-axis a specified number of degrees. The second sub-volume may be rotated clockwise or counterclockwise. The relative rotational position between the first sub-volume and the second sub-volume is hereinafter referred to as “the current degree of rotation.”

The alignment service calculates a similarity metric for the current degree of rotation (406). In general, the alignment service compares corresponding voxels among the first sub-volume and the second sub-volume to determine their similarity. For example, if each sub-volume is mapped to a coordinate plane, a voxel from the first sub-volume located at a coordinate of (6, 7, −8) is compared to a voxel from the second sub-volume at the same coordinate. As the second sub-volume is rotated, the voxel located at the (6, 7, −8) coordinate changes leading to a new comparison. A similarity score or metric can be computed for each pair of voxels and an overall similarity score determined based on the average of all the pairs.

The similarity metric can be calculated using any of the formulas (1), (2), and (3) described above, such as correlation coefficient and mutual information. In some implementations, the alignment service may identify features in the sub-volumes or entire core sample images such as formation striations or gradients and align the core sample images based on matching the angle and direction of the identified features. A similarity metric can be determined based on differences between the angles and directions of the identified features. After a similarity metric for the current degree of rotation is calculated, the alignment service may store the similarity metric value or compare the value to a previously calculated value and retain the higher similarity metric value.

The alignment service determines whether there is an additional rotation to perform (408). The alignment service continues rotating the second sub-volume until the sub-volume has been rotated 360 degrees. In some implementations, the alignment service may stop the alignment operations once a similarity metric threshold has been satisfied. For example, if a similarity metric value exceeds 0.98 on a scale of 0 to 1, the alignment service may select the current degree of rotation for alignment. If there is an additional rotation to perform, the alignment service rotates the second sub-volume to the next degree of rotation (404).

If there is not an additional rotation to perform, the alignment service identifies a degree of rotation with the highest similarity metric value (410). In some implementations, if the highest similarity metric value fails to satisfy a threshold, the alignment service may repeat the calculation of similarity metrics at a finer scale of degrees than previously utilized, such as every tenth of a degree.

The alignment service aligns the first core sample image and the second core sample image at the identified degree of rotation (412). The alignment service rotates the second core sample image to the identified degree of rotation in relation to the first core sample image so that the first and second core sample images are rotationally aligned. After rotating the second core sample image, the process ends.

FIG. 5 depicts an example core sample image with fitted ellipses and a fitted cylindrical shell. FIG. 5 includes a core sample image 501 with fitted ellipses 502 and center points 503. The center points are fitted with a line 504 to serve as an axis for the core sample image 501 which can be aligned with a z-axis. Additionally, the core sample image 501 is fitted with a cylindrical shell 504. The cylindrical shell 505 is fitted to the core sample image 501 using the radii of the fitted ellipses 502. The top fraction of radii with the least residual error are selected and averaged to determine the radius of the cylindrical shell 505. The determined radius of the cylindrical shell 505 for the core sample image 501 can be compared to radii of cylindrical shells fitted to other core sample images as a quality check of the scan and alignment process. For example, if the radius of the cylindrical shell differs significantly from other radii, the core sample may not have been scanned properly or an error may have occurred when fitting the ellipses 502 to the core sample image 501.

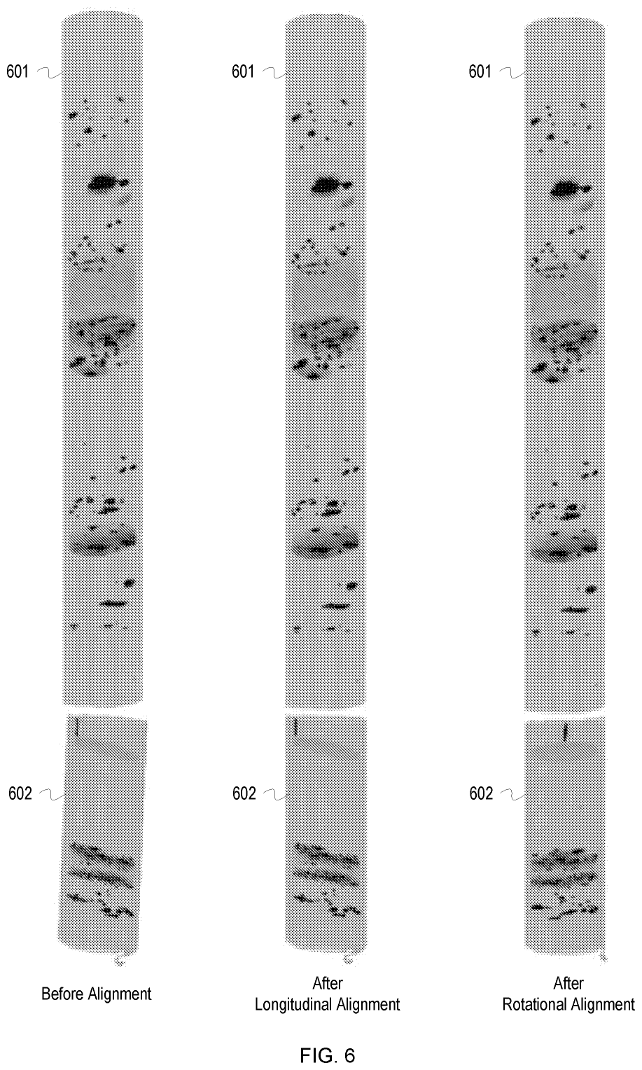

FIG. 6 illustrates the process of aligning a core sample image with a previously aligned core sample image. FIG. 6 includes a previously aligned core sample image 601 and a core sample image 602 at three different phases of the alignment process: (1) before alignment, (2) after longitudinal alignment, and (3) after rotational alignment. Before alignment, the core sample image 602 is at a different angle in relation to the core sample image 601 and a z-axis with which the core sample image 601 has been previously aligned. After longitudinal alignment, the core sample image 602 has been aligned with the z-axis and is therefore in alignment with the core sample image 601. Finally, rotational alignment is performed for the core sample image 602 in relation to the core sample image 601. Ideally, after rotational and longitudinal alignment, the core samples represented in the core sample image 601 and the core sample image 602 are aligned and positioned relative to each other as originally positioned in a formation prior to extraction.

FIG. 7 depicts two sets of core sample images before and after alignment. FIG. 7 includes a set of core sample images 701 and a set of core sample images 702 before and after performing the alignment process. The sets of core sample images 701 and 702 prior to alignment contain core sample images which are not uniformly aligned with a determined z-axis and may be rotationally out of alignment as well. After alignment, the sets of core sample images 701 and 702 are more uniformly aligned with a z-axis, which is clearly visible from the aligned aluminum tubing surrounding the core samples. FIG. 7, as opposed to some Figures above, depicts a two-dimensional image of aligned core sample images. After aligning core sample images, an alignment service may output two-dimensional images similar to those in FIG. 7 along the axial, sagittal, or coronal planes.

### Example Core Retrieval Application

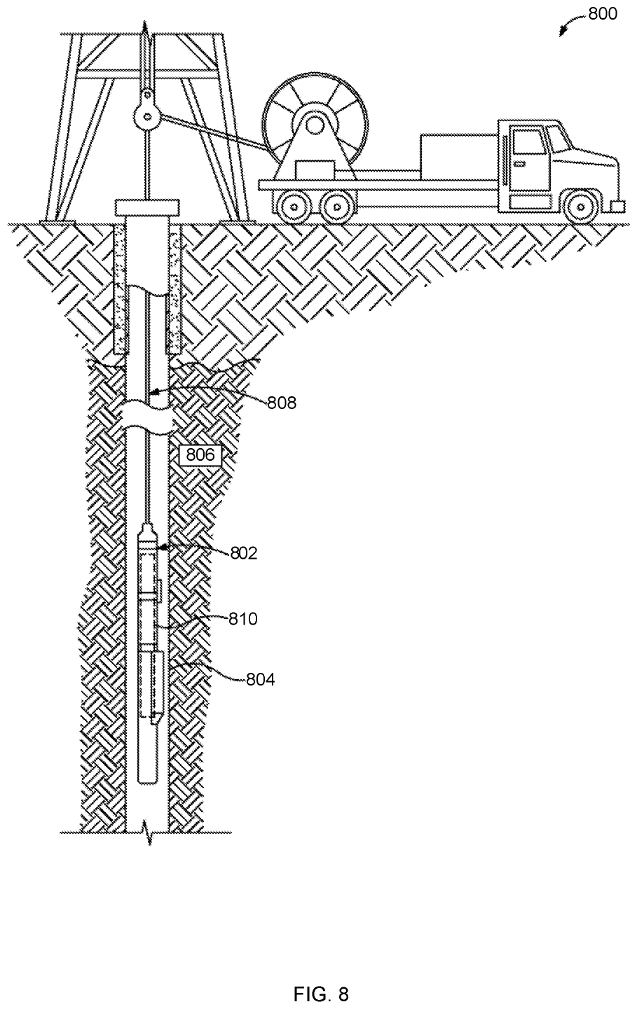

FIG. 8 depicts a schematic diagram of a core retrieval system for collecting core samples. A system 800 can be used in an illustrative logging environment with a drillstring removed, in accordance with some embodiments of the present disclosure.

FIG. 8 shows an example system 800 for collecting core samples and storing the core samples in a core holder. In FIG. 8, a coring tool 802 is placed in a wellbore 804 penetrating a subterranean formation 806 by a conveyance 808, illustrated as a wireline conveyance. In certain example embodiments, the coring tool 802 is placed in the wellbore 804 by another conveyance (e.g., coil tubing, wired coiled tubing, slickline, drill pipe, downhole tractor, and the like) that is connectable and/or communicates to the surface. The coring tool 802 includes a core holder 810. A core sample is extracted from the formation 806 and transported within the core holder 810 to the surface. The core sample is retrieved and may be scanned on site or transported to another location for scanning.

One skilled in the art would recognize the variations of the system 800 that may be employed when performing the methods described herein. For example, the system 800 may be implemented with a portion of the wellbore 804 that is off-vertical (e.g., deviated or horizontal). In certain embodiments, a control unit can be positioned at the surface, in the borehole (e.g., in the conveyance 808 and/or as part of the logging tool 802 or both (e.g., a portion of the processing may occur downhole and a portion may occur at the surface). The control unit may include a control system or a control algorithm. In certain embodiments, a control system, an algorithm, or a set of machine-readable instructions may cause the control unit to generate and provide an input signal to one or more elements of the logging tool 802, such as the sensors along the logging tool 802. The input signal may cause the sensors to be active or to output signals indicative of sensed properties.

### Variations

FIG. 1 is annotated with a series of letters A-D. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

The examples often refer to an “alignment service.” The alignment service is a construct used to refer to implementation of functionality for processing core scans and aligning core sample images. This construct is utilized since numerous implementations are possible. An alignment service may be an application executing on a workstation and/or a cloud computing resource, a particular component or components of a machine (e.g., a particular circuit card enclosed in a housing with other circuit cards/boards), machine-executable program or programs, firmware, a circuit card with circuitry configured and programmed with firmware for processing and aligning core scans, etc. The term is used to efficiently explain content of the disclosure.

The alignment service can also be referred to as a core scan processor, core image analyzer, etc. Although the examples refer to operations being performed by an alignment service, different entities can perform different operations. For instance, a dedicated co-processor or application specific integrated circuit can perform pre-processing and border pixel recognition of the core scans.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 304 and 306 can be performed in parallel or concurrently. With respect to FIG. 2, the operations of block 204 may not be necessary. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

The above description refers to iterating through items such as core sample images and degrees. The ordering of items and number of iterations can vary among implementations. For example, the above description refers to ordering core sample images according to depth although different orderings of core sample images are possible. In some implementations, the alignment service may align core sample images in a random order so long as contiguous core sample images are ultimately placed adjacent to each other. When iterating through degrees of rotations, the alignment service may iterate through each whole degree, every hundredth degree, every tenth degree, etc.

The description above refers to performing operations on three-dimensional images or scans of core samples. Similar operations can be applied to align two-dimensional images or scans of core samples. While rotational alignment is unnecessary for two-dimensional images, an alignment service could perform longitudinal alignment of the images.

Additionally, the description above describes fitting a core sample image with ellipses or circles and then fitting a cylindrical shell to the core sample image based on the radii of the fitted ellipses. In some implementations, a cylinder can be fitted directly to a core sample without the intermediate steps of fitting ellipses and determining radii of the ellipses.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

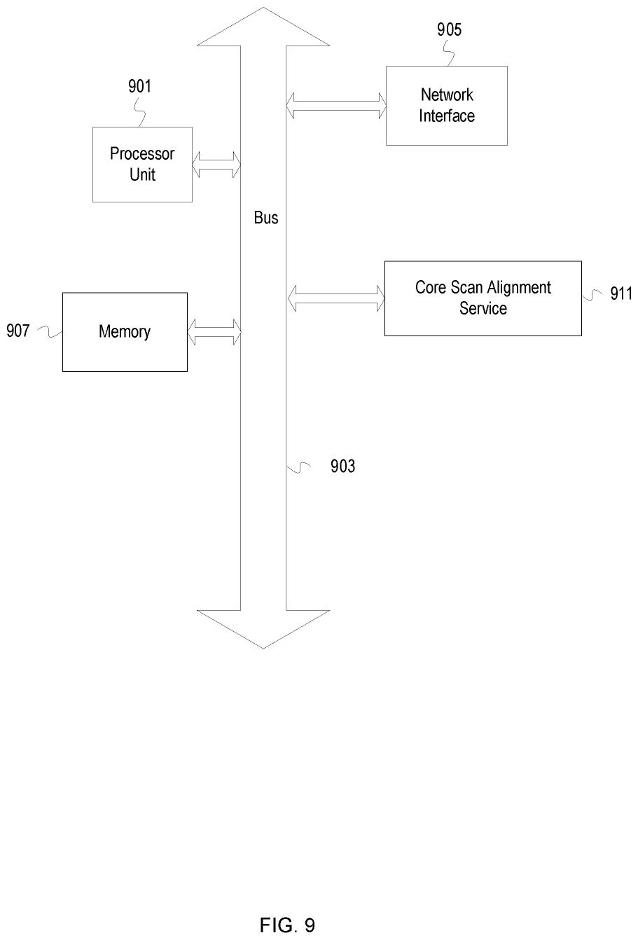

FIG. 9 depicts an example computer system with a core scan alignment service. The computer system includes a processor unit 901 (possibly including multiple processors, multiple cores, multiple nodes, and/or implementing multi-threading, etc.). The computer system includes memory 907. The memory 907 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 903 (e.g., PCI, ISA, PCI-Express, HyperTransport® bus, InfiniBand® bus, NuBus, etc.) and a network interface 905 (e.g., a Fiber Channel interface, an Ethernet interface, an internet small computer system interface, SONET interface, wireless interface, etc.). The system also includes a core scan alignment service 911. The core scan alignment service 911 processes core scans and aligns images of core samples obtained from a formation. Any one of the previously described functionalities may be partially (or entirely) implemented in hardware and/or on the processor unit 901. For example, the functionality may be implemented with an application specific integrated circuit, in logic implemented in the processor unit 901, in a co-processor on a peripheral device or card, etc. Further, realizations may include fewer or additional components not illustrated in FIG. 9 (e.g., video cards, audio cards, additional network interfaces, peripheral devices, etc.). The processor unit 901 and the network interface 905 are coupled to the bus 903. Although illustrated as being coupled to the bus 903, the memory 907 may be coupled to the processor unit 901.

While the aspects of the disclosure are described with reference to various implementations and exploitations, it will be understood that these aspects are illustrative and that the scope of the claims is not limited to them. In general, techniques for processing core scans and aligning core sample images as described herein may be implemented with facilities consistent with any hardware system or hardware systems. Many variations, modifications, additions, and improvements are possible.

### Example Embodiments

A. A method that includes determining a first center axis for a core sample extracted from a formation in a first core sample image; aligning the first center axis and a second center axis of a second core sample image with a common axis of a coordinate plane; and generating a model of the formation comprising the first core sample image and the second core sample image.

B. A non-transitory, computer-readable medium comprising program code, the program code to determine a first center axis for a core sample extracted from a formation in a first core sample image; align the first center axis and a second center axis of a second core sample image with a common axis of a coordinate plane; and generate a model of the formation comprising the first core sample image and the second core sample image.

C. An apparatus that includes a processor and a machine-readable medium having program code. The program code is executable by the processor to cause the apparatus to determine a first center axis for a core sample extracted from a formation in a first core sample image; align the first center axis and a second center axis of a second core sample image with a common axis of a coordinate plane; and generate a model of the formation comprising the first core sample image and the second core sample image.

Each of the embodiments A, B, and C may have one or more of the following additional elements in any combination.

Element 1: further comprising determining similarity values between the first core sample image and the second core sample image for each of a plurality of positions in which the first core sample image is rotated relative to the second core sample image; and rotating the first core sample image to a first position of the plurality of positions which corresponds to a highest similarity value.

Element 2: wherein determining the similarity values between the first core sample image and the second core sample image for each of a plurality of positions in which the first core sample image is rotated relative to the second core sample image comprises determining the similarity values based on at least one of correlation coefficients, mutual information, and mean squared difference.

Element 3: wherein determining the similarity values between the first core sample image and the second core sample image for each of the plurality of positions in which the first core sample image is rotated relative to the second core sample image comprises positioning the first core sample image and the second core sample image at a second position of the plurality of positions; determining a first similarity value between the first core sample image and the second core sample image at the second position based, at least in part, on a difference in intensity between one or more voxels of the first core sample image and the second core sample image; rotating the core sample in the first core sample image a number of degrees around the first center axis to position the first core sample image and the second core sample image at a third position of the plurality of positions; and determining a second similarity value between the first core sample image and the second core sample image at the third position.

Element 4: further comprising selecting a first sub-volume from the first core sample image and a second sub-volume from the second core sample image; wherein determining the similarity values between the first core sample image and the second core sample image for each of the plurality of positions comprises comparing the first sub-volume and the second sub-volume at each of the plurality of positions.

Element 5: wherein determining the first center axis for the core sample extracted from a formation in the first core sample image comprises fitting a plurality of ellipses along a length of the core sample in the first core sample image; and fitting a line to centers of the plurality of ellipses.

Element 6: wherein fitting the plurality of ellipses along the length of the core sample represented in the first core sample image comprises for each axial image of a plurality of axial images included in the first core sample image, applying binary thresholding and morphological operations to the axial image to identify a plurality of border pixels; and fitting an ellipse to the plurality of border pixels.

Element 7: further comprising fitting a cylindrical shell to the core sample in the first core sample image.

By way of non-limiting example, exemplary combinations applicable to A, B, and C include Elements 2, 3, and 4 with Element 1 and Element 6 with Element 5.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of preceding a list with the conjunction and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
determining a first center axis for a core sample extracted from a formation in a first core sample image;
aligning the first center axis and a second center axis of a second core sample image with a common axis of a coordinate plane; and
generating a model of the formation comprising the first core sample image and the second core sample image.

2. The method of claim 1 further comprising:
determining similarity values between the first core sample image and the second core sample image for each of a plurality of positions in which the first core sample image is rotated relative to the second core sample image; and
rotating the first core sample image to a first position of the plurality of positions which corresponds to a highest similarity value.

3. The method of claim 2, wherein determining the similarity values between the first core sample image and the second core sample image for each of the plurality of positions in which the first core sample image is rotated relative to the second core sample image comprises determining the similarity values based on at least one of correlation coefficients, mutual information, and mean squared difference.

4. The method of claim 2, wherein determining the similarity values between the first core sample image and the second core sample image for each of the plurality of positions in which the first core sample image is rotated relative to the second core sample image comprises:
positioning the first core sample image and the second core sample image at a second position of the plurality of positions;
determining a first similarity value between the first core sample image and the second core sample image at the second position based, at least in part, on a difference in intensity between one or more voxels of the first core sample image and the second core sample image;
rotating the core sample in the first core sample image a number of degrees around the first center axis to position the first core sample image and the second core sample image at a third position of the plurality of positions; and
determining a second similarity value between the first core sample image and the second core sample image at the third position.

5. The method of claim 2 further comprising:
selecting a first sub-volume from the first core sample image and a second sub-volume from the second core sample image;
wherein determining the similarity values between the first core sample image and the second core sample image for each of the plurality of positions comprises comparing the first sub-volume and the second sub-volume at each of the plurality of positions.

6. The method of claim 1, wherein determining the first center axis for the core sample extracted from a formation in the first core sample image comprises:
fitting a plurality of ellipses along a length of the core sample in the first core sample image; and
fitting a line to centers of the plurality of ellipses.

7. The method of claim 6, wherein fitting the plurality of ellipses along the length of the core sample represented in the first core sample image comprises:
for each axial image of a plurality of axial images included in the first core sample image, applying binary thresholding and morphological operations to the axial image to identify a plurality of border pixels; and
fitting an ellipse to the plurality of border pixels.

8. The method of claim 1 further comprising fitting a cylindrical shell to the core sample in the first core sample image.

9. An apparatus comprising:
a processor; and
a machine-readable medium having program code executable by the processor to cause the apparatus to,
determine a first center axis for a core sample extracted from a formation in a first core sample image;
align the first center axis and a second center axis of a second core sample image with a common axis of a coordinate plane; and
generate a model of the formation comprising the first core sample image and the second core sample image.

10. The apparatus of claim 9 further comprising program code to:
determine similarity values between the first core sample image and the second core sample image for each of a plurality of positions in which the first core sample image is rotated relative to the second core sample image; and
rotate the first core sample image to a first position of the plurality of positions which corresponds to a highest similarity value.

11. The apparatus of claim 10, wherein the program code to determine the similarity values between the first core sample image and the second core sample image for each of the plurality of positions in which the first core sample image is rotated relative to the second core sample image comprises program code to determine the similarity values based on at least one of correlation coefficients, mutual information, and mean squared difference.

12. The apparatus of claim 10, wherein the program code to determine the similarity values between the first core sample image and the second core sample image for each of the plurality of positions in which the first core sample image is rotated relative to the second core sample image comprises program code to:
position the first core sample image and the second core sample image at a second position of the plurality of positions;
determine a first similarity value between the first core sample image and the second core sample image at the second position based, at least in part, on a difference in intensity between one or more voxels of the first core sample image and the second core sample image;
rotate the core sample in the first core sample image a number of degrees around the first center axis to position the first core sample image and the second core sample image at a third position of the plurality of positions; and
determine a second similarity value between the first core sample image and the second core sample image at the third position.

13. The apparatus of claim 10 further comprising program code to:
select a first sub-volume from the first core sample image and a second sub-volume from the second core sample image;
wherein the program code to determine the similarity values between the first core sample image and the second core sample image for each of the plurality of positions comprises program code to compare the first sub-volume and the second sub-volume at each of the plurality of positions.

14. The apparatus of claim 9, wherein the program code to determine the first center axis for the core sample extracted from a formation in the first core sample image comprises program code to:
fit a plurality of ellipses along a length of the core sample in the first core sample image; and
fit a line to centers of the plurality of ellipses.

15. The apparatus of claim 14, wherein the program code to fit the plurality of ellipses along the length of the core sample represented in the first core sample image comprises program code to:
for each axial image of a plurality of axial images included in the first core sample image, apply binary thresholding and morphological operations to the axial image to identify a plurality of border pixels; and
fit an ellipse to the plurality of border pixels.

16. The apparatus of claim 9 further comprising program code to fit a cylindrical shell to the core sample in the first core sample image.

17. A system comprising:
a coring tool configured to extract a first core sample and a second core sample from a formation;
a scanner configured to scan the first core sample to generate a first core sample image and scan the second core sample to generate a second core sample image;
a processor; and
a machine-readable medium having program code executable by the processor to cause the system to,
determine a first center axis for the first core sample in the first core sample image;
align the first center axis and a second center axis for the second core sample in the second core sample image with a common axis of a coordinate plane; and
generate a model of the formation comprising the first core sample image and the second core sample image.

18. The system of claim 17 further comprising:
a conveyance connected to the coring tool configured to position the core tool within the formation; and
a core holder of the core tool configured to retain a core sample during extraction from the formation.

19. The system of claim 17 further comprising program code:
determine similarity values between the first core sample image and the second core sample image for each of a plurality of positions in which the first core sample image is rotated relative to the second core sample image; and
rotate the first core sample image to a first position of the plurality of positions which corresponds to a highest similarity value.

20. The system of claim 19, wherein the program code to determine the similarity values between the first core sample image and the second core sample image for each of the plurality of positions in which the first core sample image is rotated relative to the second core sample image comprises program code to determine the similarity values based on at least one of correlation coefficients, mutual information, and mean squared difference.
